(19) United States
(12) Patent Application Publication
(10) Pub. No.: US 2020/0147706 A1
(43) Pub. Date: May 14, 2020

(54) DEBURRING TOOL

(71) Applicant: Klingelnberg AG, Zurich (CH)

(72) Inventor: Karl-Martin Ribbeck, Remscheid (DE)

(21) Appl. No.: 16/673,266

(22) Filed: Nov. 4, 2019

(30) Foreign Application Priority Data
Nov. 9, 2018 (DE) 202018106368.5

(51) Int. Cl. B23F 19/10; B24B 9/02

(52) U.S. Cl. CPC B23F 19/10; B24B 9/02

(57) ABSTRACT

A deburring tool including a tool base body defining a blade shaft and a bar blade defining a cutting profile having a main cutting edge and a secondary cutting edge, wherein at least a portion of the main cutting edge and/or the secondary cutting edge is concave or convex, the bar blade is held in the blade shaft, and the deburring tool is configured to deburr a bevel gear.

### CROSS-REFERENCE TO RELATED APPLICATIONS

This application claims the benefit under 35 U.S.C. § 119(e) to German utility patent application no. DE 20 2018 106 368.5 filed Nov. 9, 2018, and registered Jan. 22, 2019, which is hereby expressly incorporated by reference as part of the present disclosure.

### FIELD OF THE INVENTION

The present disclosure relates to a deburring tool for deburring a bevel gear, having a tool base body and a bar blade, wherein the bar blade is arranged and clamped in a blade shaft of the tool base body and wherein the bar blade has a cutting profile with a main cutting edge, a head cutting edge and a secondary cutting edge.

### BACKGROUND

Deburring tools are used to remove the burrs that occur in the heel or toe area of the tooth gaps after soft machining of a bevel gear blank.

For deburring, it is known to use bar blades with cutting profiles that have a straight main and secondary cutting edge. The disadvantage here is that a number of enveloping cuts are required in order to approach the curved edge shape of the teeth and reliably remove the burrs, which results in an increased machining time for the component in question.

In addition, there is a customer demand for a visually appealing machining result, so that the enveloping cuts of the deburring process in the edge area adjacent to the tooth flanks should not be visible to the naked eye. For this purpose, a further increased number of enveloping cuts is required, depending on the flank shape, in order to achieve not only reliable deburring but also an improved machining result with regard to the overall optical impression.

Another frequent requirement is that the deburring phases should be as uniform and accurate as possible. For example, the customer can specify that a continuous deburring phase of 0.5 mm×45° on the heel or toe side is to be produced.

### SUMMARY

Against this background, the present disclosure is based on the technical problem of specifying a deburring tool that does not have the disadvantages described above, or at least has them to a lesser extent, and in particular enables deburring with fewer enveloping cuts as well as an improved appearance of the machined or deburred areas of a bevel gear.

The disclosure relates to a deburring tool for deburring a bevel gear, having a tool body and with a bar blade, wherein the bar blade is arranged and clamped in a blade shaft of the tool body and wherein the bar blade has a cutting profile with a main cutting edge and a secondary cutting edge. The main cutting edge is shaped concave or convex at least in sections. Alternatively or in addition, the secondary cutting edge is shaped concave or convex at least in sections.

The convex or concave cutting edge shape can reduce the number of enveloping cuts required to approach the tooth form in the edge areas of the teeth of a bevel gear to be deburred. Deburring can therefore be carried out more quickly, wherein the deburred edges also have a higher quality appearance, as the cutting edge shape is at least partially adapted to the tooth shape in the edge area.

Accordingly, the main cutting edge and/or the secondary cutting edge are adapted, in particular at least in sections, to an edge profile at the heel or toe end of the teeth of a bevel gear to be deburred in order to reduce the number of enveloping cuts required during deburring and at the same time to improve the overall visual impression of the deburred bevel gear.

The deburring tool is characterized according to a further embodiment of the disclosure in that the blade shaft, starting from a circumferential enveloping surface of the tool base body, extends at least in sections in the direction of the axis of rotation of the tool base body, wherein the bar blade with its cutting edge profile is cantilevered over the surface. In other words, the bar blade is oriented transversely to the axis of rotation. Accordingly, it may be provided that a longitudinal extension of the bar blade and the blade shaft starting from an axis of rotation of the tool body is substantially radially oriented. This enables rapid, continuous deburring of the teeth of a bevel gear.

It is understood that a longitudinal axis of the blade shaft or a longitudinal axis of the bar blade can be extended essentially in the direction of the axis of rotation or radially, but can be arranged obliquely to the axis of rotation and optionally may not intersect it. Unlike a bar blade head, which is used to produce the tooth gaps of a bevel gear during soft machining, the blade shaft is therefore not oriented into a planar side of a tool body and not essentially parallel to the axis of rotation.

It may be provided that a longitudinal extension of the bar blade and the blade shaft are substantially perpendicular to an axis of rotation of the tool body.

Two or more circumferentially projecting bar blades can be provided, wherein the bar blades are arranged at equidistant angular distances relative to each other. Each bar blade is assigned a blade shaft. For example, the deburring tool can have exactly two, exactly three or exactly four bar blades, each of which is designed for deburring a bevel gear. According to at least some alternative embodiments, more than four bar blades can be provided.

According to a further embodiment, it is provided that the bar blade is arranged for deburring on the heel and/or toe side adjacent to the concave flank of a bevel gear and has a main cutting edge and/or secondary cutting edge which is convex at least in sections and/or the bar blade is arranged for deburring on the heel and/or toe side adjacent to the convex flank of a bevel gear and has a main cutting edge and/or secondary cutting edge which is concave at least in sections.

Alternatively or in addition, it may be provided that the bar blade is arranged for deburring on the heel and/or toe side adjacent to the convex flank of a bevel gear with five or fewer enveloping cuts, in particular adapted for deburring on the heel and/or toe side adjacent to the convex flank of a bevel gear with three or fewer enveloping cuts.

Alternatively or in addition, the bar blade for deburring on the heel and/or toe side may be arranged adjacent to the concave flank of a bevel gear with five or fewer enveloping cuts, in particular adapted for deburring on the heel and/or toe side adjacent to the concave flank of a bevel gear with three or fewer enveloping cuts.

It may be provided that the bar blade is arranged for heel-side or toe-side deburring adjacent to the concave flank of a bevel gear and that the bar blade is also arranged for heel-side and/or toe-side deburring adjacent to the convex flank of a bevel gear, wherein the bar blade has a main cutting edge which is convex at least in sections and a secondary cutting edge which is concave at least in sections, or the bar blade has a main cutting edge which is concave at least in sections and a secondary cutting edge which is convex at least in sections. A single deburring tool can therefore be used to deburr both the profile edges of the teeth of a bevel gear adjacent to the concave flanks and the profile edges of the teeth of a bevel gear adjacent to the convex flank on the heel and/or toe side.

It may be provided that the main cutting edge is shaped concave at least in sections and the secondary cutting edge is shaped concave at least in sections. Thus, an essentially biconcave cutting edge profile can be specified.

It may be provided that the main cutting edge is shaped convex at least in sections and the secondary cutting edge is shaped convex at least in sections. Thus, an essentially biconvex cutting edge profile can be specified.

It may be provided that the main cutting edge is shaped convex at least in sections and the secondary cutting edge is shaped straight at least in sections.

It may be provided that the main cutting edge is shaped concave at least in sections and the secondary cutting edge is shaped straight at least in sections.

It may be provided that the main cutting edge is shaped straight at least in sections and the secondary cutting edge is shaped convex at least in sections.

It may be provided that the main cutting edge is shaped straight at least in sections and the secondary cutting edge is shaped concave at least in sections.

It may be provided that the main cutting edge is shaped concave at least in sections and the secondary cutting edge is shaped convex at least in sections.

It may be provided that the main cutting edge is shaped convex at least in sections and the secondary cutting edge is shaped concave at least in sections.

According to a further embodiment it is provided that a head cutting edge is formed between the main cutting edge and the secondary cutting edge, in particular that the main and secondary cutting edges merge into the head cutting edge in a stepless manner, further in particular that the head cutting edge is shaped concave and/or convex and/or linear at least in sections.

According to a further embodiment it is provided that no head cutting edge is formed between the main cutting edge and the secondary cutting edge, in particular that the main and secondary cutting edges converge or adjoin one another directly at an angle n of an edge or a point, in particular converge or adjoin one another at an acute angle.

The terms “main cutting edge”, “head cutting edge” and “secondary cutting edge” only serve the purpose of structurally specifying the bar blade or bar blades, but do not predetermine that each of the mentioned areas “main cutting edge”, “head cutting edge” and “secondary cutting edge” of a cutting profile actually has a cutting effect during the deburring process.

Thus it is possible that a bar blade with main cutting edge, head cutting edge and secondary cutting edge is only used for deburring or chamfering a concave and/or convex flank, wherein only the main cutting edge or secondary cutting edge is in cutting engagement with the bevel gear.

Alternatively, it can be provided, for example, that the entire tooth profile is deburred or chamfered on the heel and/or toe side, wherein each cutting edge, i.e. the main cutting edge, the head cutting edge and the secondary cutting edge, is used to deburr the teeth of a bevel gear on the heel and/or toe side on the tooth head, the convex flank, the tooth root and the concave flank.

By deburring, for example, a circumferentially extending chamfer on the heel side diameter can be produced and/or a circumferentially extending chamfer on the toe side diameter can be produced. For example, a continuous heel-side and/or toe-side deburring chamfer of 0.5 mm×45° can be produced.

Alternatively, it can be provided for example that the concave and/or convex flanks may be deburred on the heel and/or toe side, while the tooth root and head are not deburred.

Alternatively, it can be provided for example that the concave and/or convex flanks and the tooth root are deburred on the heel and/or toe side, while the tooth head is not deburred.

Alternatively, it can be provided for example that the concave and/or convex flanks and the tooth head are deburred on the heel and/or toe side, while the tooth root is not deburred.

### BRIEF DESCRIPTION OF THE DRAWINGS

Exemplary embodiments, which are understood not to be limiting, will be described in greater detail hereafter with reference to the drawings.

FIG. 1 a deburring tool for deburring a bevel gear in a front view;

FIG. 2 the deburring tool from FIG. 1 in a side view;

FIG. 3 another deburring tool for deburring a bevel gear in a front view;

FIG. 4 the deburring tool from FIG. 3 in a side view.

### DETAILED DESCRIPTION

Terms are used in conjunction with the present description which are also used in relevant publications and patents. However, it is to be noted that the use of these terms is merely to serve for better comprehension. The inventive concepts and the scope of protection of the claims for protection are not to be restricted in the interpretation by the specific selection of the terms. The invention may be readily transferred to other term systems and/or technical fields. The terms are to be applied accordingly in other technical fields.

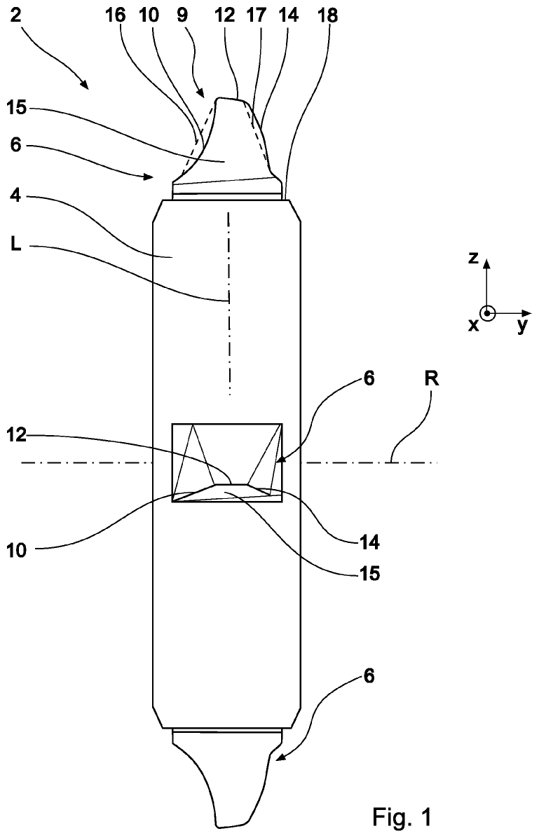

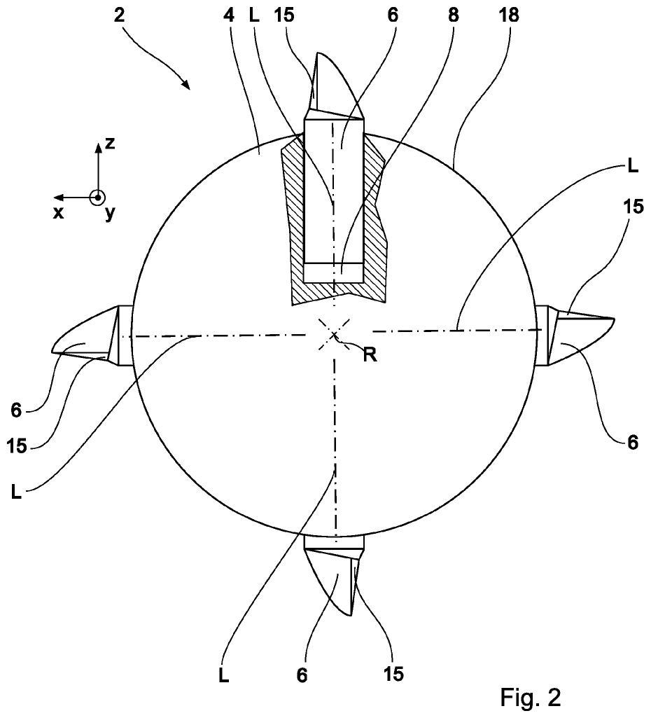

FIG. 1 shows deburring tool 2 for deburring a bevel gear. The deburring tool 2 has a tool base body 4 and four bar blades 6. The bar blades 6 are each arranged and clamped in an assigned blade shaft 8 of the tool base body 4, as shown as an example in the partial section according to FIG. 2.

Each of the bar blades 6 has a cutting edge profile 9, having a main cutting edge 10, a head cutting edge 12 and a secondary cutting edge 14, adjacent to a cutting face 15.

The main cutting edge 10 of each bar blade 6 is shaped concave. The secondary cutting edge 14 of each bar blade 6 is shaped convex.

To illustrate the concave or convex shape, the main cutting edge 10 and the secondary cutting edge 14 of the bar blade 6 shown in FIG. 1 in the upper image area are each assigned a dashed auxiliary line 16, 17, which represent a straight cutting edge profile as implemented in the prior art. Thus the main cutting edge 10 is set back concave to the adjacent auxiliary line 16. The secondary cutting edge 14 is convex over the auxiliary line 17, i.e. curved outwards. The shown cutting edge shape allows a reduced number of enveloping cuts when deburring a bevel gear.

As can be seen in FIG. 2, the blade shaft 8 of a respective bar blade 6, starting from a circumferential enveloping surface 18 of the tool base body 4, extends at least in sections in the direction of the axis of rotation R of the tool base body 4.

The bar blades 6 with their cutting profile 9 each extend projecting over the enveloping surface 18.

A longitudinal extension along a longitudinal axis L of a respective bar blade 6 and the associated blade shaft 8 is essentially radially oriented, starting from the axis of rotation R of the tool base body 4. A longitudinal axis L of a respective bar blade 6 and the associated blade shaft 8 extends essentially perpendicularly to the axis of rotation R of the tool base body 4.

The axis of rotation R is oriented in this case parallel to the y-axis of the displayed Cartesian coordinate system.

The deburring tool 2 has four circumferentially projecting bar blades 6, wherein the bar blades 6 are arranged relative to each other at equidistant angular distances.

The bar blades 6 are designed for deburring adjacent to the concave and convex flanks of the teeth of a bevel gear after soft machining of a bevel gear blank.

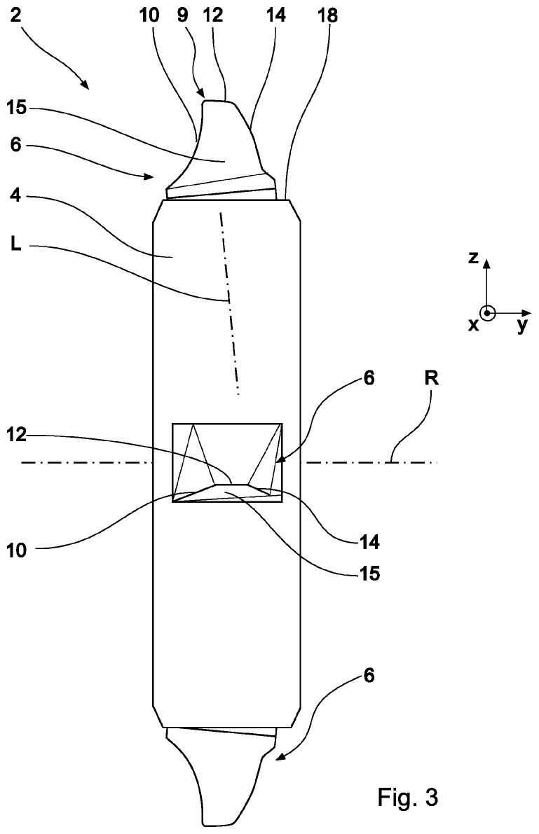

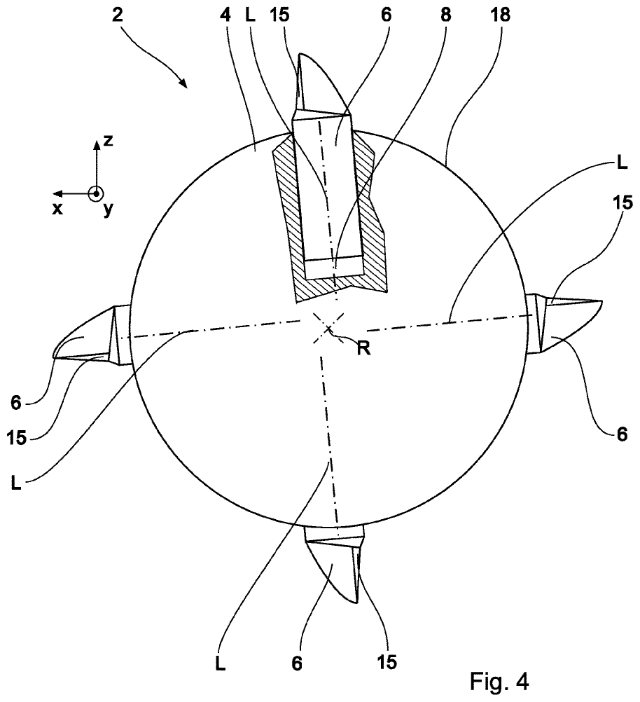

FIGS. 3 and 4 show a variant of a deburring tool 2 disclosed herein. Compared to the variant described above with reference to FIGS. 1 and 2, the blade shafts 8 and the bar blades 6 are still essentially radially extended, but oriented in a tilted or inclined manner. The bar blades 6, for example, are tilted as shown in FIG. 3 by less than 10° in relation to the illustration shown in FIG. 1, wherein the longitudinal axes L are disposed perpendicular to the axis of rotation R in FIG. 1 Similarly, as shown in FIG. 4, the bar blades 6 are tilted by less than 10° in relation to the illustration shown in FIG. 2, wherein the longitudinal axes L are disposed perpendicular to the axis of rotation R in FIG. 2.

What is claimed is:

1. A deburring tool, comprising
a tool base body defining a blade shaft; and
at least one bar blade defining a cutting profile having a main cutting edge and a secondary cutting edge, wherein at least portions of one or more of the main cutting edge or the secondary cutting edge are concave or convex; and
wherein said at least one bar blade is held in the blade shaft and the deburring tool is configured to deburr a bevel gear.

2. The deburring tool according to claim 1, wherein
the tool base body defines an axis of rotation thereof; and
the at least one bar blade and the blade shaft each define a longitudinal extension thereof oriented one or more of substantially radially or substantially perpendicular to the axis of rotation.

3. The deburring tool according to claim 1, wherein one or more of
(a) at least portions of one or more of the main cutting edge or the secondary cutting edge are convex and the at least one bar blade is configured to deburr one or more of a heel-side or a toe-side adjacent to a concave flank of a bevel gear tooth; or
(b) at least portions of one or more of the main cutting edge or the secondary cutting edge are concave and the at least one bar blade is configured to deburr one or more of a heel-side or a toe-side adjacent to a convex flank of a bevel gear tooth.

4. The deburring tool according to claim 1, wherein the at least one bar blade is configured to deburr one or more of a heel-side or a toe-side adjacent to one or more of a convex flank or a concave flank of a bevel gear tooth in no more than five enveloping cuts.

5. The deburring tool according to claim 4, wherein the at least one bar blade is configured to deburr one or more of a heel-side or a toe-side adjacent to one or more of a convex flank or a concave flank of a bevel gear tooth in no more than three enveloping cuts.

6. The deburring tool according to claim 1, wherein
the at least one bar blade is configured to deburr one or more of a heel-side or a toe-side adjacent to a concave flank and a convex flank of a bevel gear tooth; and
one or more of (a) at least portions of the main cutting edge are convex and at least portions of the secondary cutting edge are concave; or (b) at least portions of the main cutting edge are concave and at least portions of the secondary cutting edge are convex.

7. The deburring tool according to claim 1, wherein the at least one bar blade includes at least two circumferentially projecting bar blades spaced substantially equidistantly angularly relative to each other.

8. The deburring tool according to claim 1, wherein one or more of:
at least portions of the main cutting edge are concave and at least portions of the secondary cutting edge are concave;
at least portions of the main cutting edge are convex and at least portions of the secondary cutting edge are convex;
at least portions of the main cutting edge are convex and at least portions of the secondary cutting edge are substantially straight;
at least portions of the main cutting edge are concave and at least portions of the secondary cutting edge are substantially straight;
at least portions of the main cutting edge are substantially straight and at least portions of the secondary cutting edge are convex;
at least portions of the main cutting edge are substantially straight and at least portions of the secondary cutting edge are concave;
at least portions of the main cutting edge are concave and at least portions of the secondary cutting edge are convex; or
at least portions of the main cutting edge are convex and at least portions of the secondary cutting edge are concave.

9. The deburring tool according to claim 1, wherein
(a) the at least one bar blade defines a head cutting edge between the main cutting edge and the secondary cutting edge, or
(b) the at least one bar blade does not define a head cutting edge between the main cutting edge and the secondary cutting edge.

10. The deburring tool according to claim 9, wherein the head cutting edge is defined by a merger of the main cutting edge and the secondary cutting edge without steps.

11. The deburring tool according to claim 10, wherein at least portions of the head cutting edge are one or more of concave, convex or substantially straight.

12. The deburring tool according to claim 9, wherein the at least one bar blade does not define a head cutting edge between the main cutting edge and the secondary cutting edge and the main cutting edge and the secondary cutting edge converge at an acute angle to each other.

13. The deburring tool according to claim 1, wherein
the tool base body defines a circumferential surface thereof and an axis of rotation thereof;
at least portions of the blade shaft extend beyond the circumferential surface in a direction of the axis of rotation; and
a portion of the at least one bar blade and the cutting profile projects outward of the circumferential surface.

14. The deburring tool according to claim 13, wherein the at least one bar blade and the blade shaft each define a longitudinal extension thereof oriented one or more of substantially radially or substantially perpendicular to the axis of rotation.

15. The deburring tool according to claim 13, wherein one or more of
(a) at least portions of one or more of the main cutting edge or the secondary cutting edge are convex and the at least one bar blade is configured to deburr one or more of a heel-side or a toe-side adjacent to a concave flank of a bevel gear tooth; or
(b) at least portions of one or more of the main cutting edge or the secondary cutting edge are concave and the at least one bar blade is configured to deburr one or more of a heel-side or a toe-side adjacent to a convex flank of a bevel gear tooth.

16. The deburring tool according to claim 13, wherein the at least one bar blade is configured to deburr one or more of a heel-side or a toe-side adjacent to one or more of a convex flank or a concave flank of a bevel gear tooth in no more than five enveloping cuts.

17. The deburring tool according to claim 16, wherein the at least one bar blade is configured to deburr one or more of a heel-side or a toe-side adjacent to one or more of a convex flank or a concave flank of a bevel gear tooth in no more than three enveloping cuts.

18. The deburring tool according to claim 13, wherein
the at least one bar blade is configured to deburr one or more of a heel-side or a toe-side adjacent to a concave flank and a convex flank of a bevel gear tooth; and
one or more of (a) at least portions of the main cutting edge are convex and at least portions of the secondary cutting edge are concave; or (b) at least portions of the main cutting edge are concave and at least portions of the secondary cutting edge are convex.

19. The deburring tool according to claim 13, wherein the at least one bar blade includes at least two circumferentially projecting bar blades spaced substantially equidistantly angularly relative to each other.

20. The deburring tool according to claim 13, wherein one or more of:
at least portions of the main cutting edge are concave and at least portions of the secondary cutting edge are concave;
at least portions of the main cutting edge are convex and at least portions of the secondary cutting edge are convex;
at least portions of the main cutting edge are convex and at least portions of the secondary cutting edge are substantially straight;
at least portions of the main cutting edge are concave and at least portions of the secondary cutting edge are substantially straight;
at least portions of the main cutting edge are substantially straight and at least portions of the secondary cutting edge are convex;
at least portions of the main cutting edge are substantially straight and at least portions of the secondary cutting edge are concave;
at least portions of the main cutting edge are concave and at least portions of the secondary cutting edge are convex; or
at least portions of the main cutting edge are convex and at least portions of the secondary cutting edge are concave.
